(19) United States
(12) Patent Application Publication
(10) Pub. No.: US 2024/0307903 A1
(43) Pub. Date: Sep. 19, 2024

(54) Combination Chemical Dispenser

(71) Applicant: John B. Brandreth, III, Canton, GA (US)

(72) Inventor: John B. Brandreth, III, Canton, GA (US)

(21) Appl. No.: 18/185,639

(22) Filed: Mar. 17, 2023

(51) Int. Cl. B05B 7/26; B01F 21/20; B01F 25/316

(52) U.S. Cl. CPC B05B 7/26; B01F 21/22; B01F 25/316

(57) ABSTRACT

A device for dispensing chemical solutions into a liquid flow, alone or in combination with a filter cartridge. Said chemical solution is created by dissolving up to two chemical solutes contained within chemical cartridges into said liquid flow. The device is comprised of a lower chemical cartridge containing a first solute connected to an upper chemical cartridge containing a second solute, and a dispenser which allows said liquid flow to continue through the flow network. The device allows for higher concentrations of a single solute to be introduced into said liquid flow than present techniques or allows for the introduction of multiple solutes into said liquid flow within the same dispenser system.

### BACKGROUND OF THE INVENTION

This invention relates generally to the field of dispenser devices used to introduce small quantities of a chemical solution into a liquid flow by dissolving a solid or granular chemical solute. More particularly, the invention relates to such devices to be used as a component in assemblies of the type commonly used for filtration of water in circulation or supply systems where the rate of introduction of the dissolved chemical into the water is controlled in a manner related to the flow volume of the water stream to ensure proper concentration percentage.

It is desirable or necessary in many water supply or recirculation systems, such as water for household or industrial use, or water for use in spas and pools, to add certain chemicals to the water to control bacterial or fungal growth, corrosion, scale deposits, etc. Commonly known additives include chlorine, polyphosphate or sodium silicate. Such additives are typically supplied in solid or granular form for ease of handling and must therefore be dissolved in liquid. It is imperative that the chemical additives be supplied in the proper concentration. Many conventional systems fail these criteria, the mechanisms being unable to prevent variations in concentration and introduction rates, especially in circumstances where the water flow is not continuous and varies in pressure. Furthermore, conventional systems only allow for the introduction of a single additive per device unit and are limited by the size of the filter system housing.

Simplistic solid chemical additive mechanisms simply divert all or a portion of the water flow stream through a container holding a solid chemical. The water flowing from the container will include an amount of dissolved chemical. These devices suffer from a lack of dispensing control, since the amount of chemical present in the outflow is dependent on the volume of solid chemical in the container. As that volume decreases, the concentration of dissolved chemical in the outflow also decreases. Additionally, this type of system produces a highly concentrated chemical surge when water flow is resumed after being shut off for a period of time, since the lack of flow allows the chemical solution to become saturated. Finally, variation in the water flow rate will not correspondingly alter the dissolving rate of the chemical, producing incorrect concentration amounts in the outflow.

Attempts have been made to develop a mechanism which addresses the problems encountered in correctly metering and controlling the chemical introduction and concentration rates, but known systems are either overly complicated or do not fully solve all the problems set forth above. A complicated mechanism is described in U.S. Pat. No. 4,780,197 to Schuman, which discloses a flow-through chemical dispenser cartridge positioned within the internal core of a filter which requires one or more operational valves to perform effectively. A more simplified approach is shown in U.S. Pat. No. 4,347,224 to Beckert et al. This patent discloses a flow housing which contains an internally mounted chemical cartridge. A small amount of the water flow is diverted into the bottom of the chemical cartridge and the chemical solution is drawn through a small aperture in the top of the cartridge by the pressure differential created by the flow of the bulk of the water passing through the housing. This apparatus provides a simple approach to solving the problems encountered in standard solid chemical systems, but the mechanism is just a variation of the standard system where a portion of the water stream is passed through the solid chemical before being returned to the main flow stream. The distinction in Beckert et al. is that the cartridge containing the solid chemical is mounted internal to a large housing through which all the water flows. The sizing of the cartridge is such to create an annular passage down to the bottom of the chemical cartridge, where the water flows through a plurality of liquid inlet holes, past the chemical and out the liquid outlet hole. In effect, the annular passage is just a substitute for a small bypass conduit as found in many old systems, and the problems associated with variations in concentration and surging would still be present.

The problems set forth above have been addressed through various devices in my earlier patents U.S. Pat. No. 5,580,448, issued Dec. 3, 1996, U.S. Pat. No. 6,267,886, issued Jul. 31, 2001, U.S. Pat. No. 6,280,617, issued Aug. 28, 2001, U.S. Pat. No. 6,855,252, issued Feb. 15, 2005, U.S. Pat. No. 8,444,929, issued May 21, 2013, and U.S. Pat. No. 8,728,405, issued May 20, 2014, the disclosures of which are incorporated herein by reference. However, a drawback inherent in these patents is that the chemical dispenser units are designed to be retained within the standard housings, bowls or bells used in combination with the standard inline base members and standard filters. As such, the chemical dispenser units are limited in size, and cannot provide adequately controlled concentration of chemical solution into the water flow. Additionally, the previously described patents could not introduce more than one chemical solute into the water flow.

It is an object of this invention to provide a chemical dispenser device which provides a steady state concentration of dissolved chemical, which introduces the chemical solution into the main water stream in amounts directed related to water flow rate or volume to maintain precise percentages of chemical solution, which does not produce excessive chemical concentration during periods of no water flow, and which does not introduce excessive amounts of dissolved chemical when water flow is resumed, and wherein the chemical dispenser device is structured such that the amount of the chemical is not limited by the size of the standard housing, and further wherein in certain embodiments the volume of chemical and the dispensing rate can be changed by replacing certain components of the assembly, and further wherein in certain embodiments at least two different chemicals can be introduced into the chemical solution without the need to pre-mix said chemicals, and further wherein in certain embodiments the concentration of a single chemical solute can be doubled without modifying the size of the device components.

### SUMMARY OF THE INVENTION

The invention comprises a chemical dispensing device which is structured to be incorporated within a flow-through filter cartridge for water purification, the filer cartridge having a hollow interior or bore, open on both an upper end and a lower end, wherein the body of said filter cartridge is porous. When placed into a housing, the lower end of said filter cartridge is sealed and the water to be filtered is delivered around the exterior of said filter cartridge, passes through the porous filter body into the hollow interior, and then exits through the upper end of said filter cartridge.

The chemical dispensing device, generally cylindrical in form, comprises a lower cartridge member having a cartridge top, a lower cartridge wall, a sealed base, a base flange extending radially outward from said sealed base, a primary inflow aperture disposed though said lower cartridge wall, a primary outflow aperture disposed through said cartridge top, and a hollow interior within which a primary chemical solute is deposited such that a sufficient gap exists between the top of the deposit and the cartridge top to allow water to flow into said primary inflow aperture, dissolve a portion of the chemical solute, and flow out of said primary outflow aperture. The chemical dispensing device further comprising an upper cartridge member having a closed bottom, an upper cartridge wall, a top opening, and a hollow interior within which a secondary chemical solute deposited. The chemical dispensing device further comprising a dispensing member having a a dispensing wall, a bottom opening, a secondary inflow aperture disposed through said dispensing wall, a flow separating member bisecting said dispensing wall, a secondary outflow aperture disposed through said flow separating member, a flow aperture disposed through the outer perimeter of said dispensing wall, a dispensing opening disposed through the top of said dispensing wall, a sealing flange extending radially outward from said dispensing opening. Said top opening of said upper cartridge member is partially inserted into said bottom opening of said dispensing member such that a void is formed between said flow separating member and the top of said secondary chemical solute deposit, wherein the water flow may enter said void through said secondary inflow aperture, dissolve a portion of said secondary chemical solute, and exit through said secondary outflow aperture.

Said base flange extends radially outward from said closed base perpendicular to the central axis of said lower cartridge member and is of sufficient size to seal off said lower open end of said filter cartridge external to said lower cartridge member when said dispensing device is inserted into said hollow interior of said filter cartridge. Said sealing flange member extends radially outward from said dispensing opening perpendicularly to the central axis of the dispensing member and is a relatively thin member presenting generally planar upper and lower surfaces. The sealing flange member is adapted to be received and retained between the end wall of said filter cartridge member and a retention structure of a housing containing said filter cartridge member, typically in combination with a washer gasket that is compressed by said retention structure of said housing, such combinations of filter cartridge and housing being well known in the art. The perimeter of said sealing flange member extends radially from said dispensing wall of said dispensing member sufficient distance to abut a portion of the end wall and thus seal said upper opening of said filter cartridge on the exterior side of said dispensing member, such that all water exiting said filter cartridge must flow through said dispensing device for treatment.

### BRIEF DESCRIPTION OF THE DRAWINGS

FIG. 1 is a cross sectional view of the chemical dispensing device oriented along its vertical axis and showing it inserted within a cylindrical filter cartridge of typical structure.

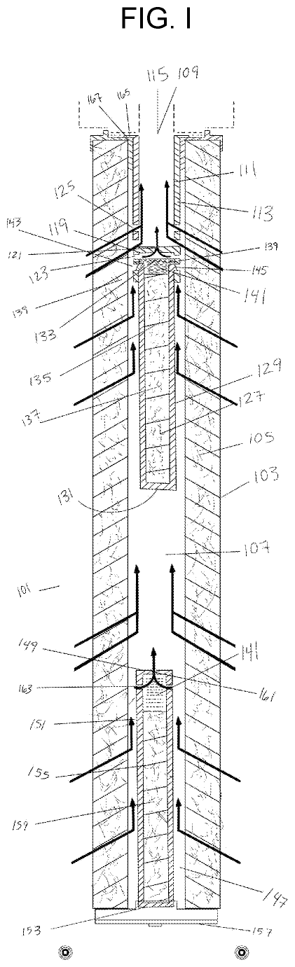

FIG. 2 is a cross sectional view of the lower cartridge member and base flange oriented along their vertical axis and showing their conjunction within a cylindrical filter cartridge of typical structure.

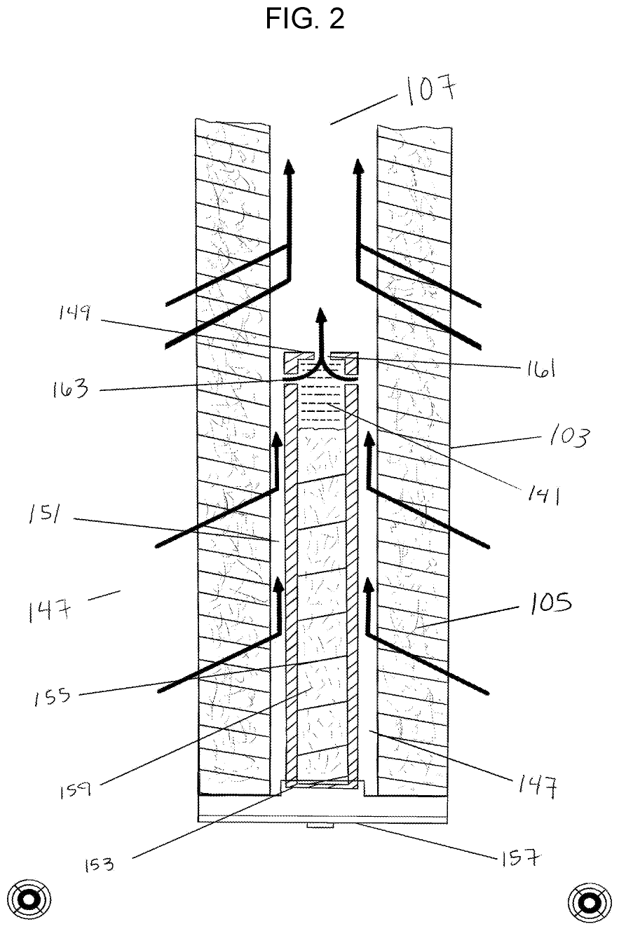

FIG. 3 is a cross sectional and top-down view of the lower cartridge member and base flange showing the relative positioning of each element.

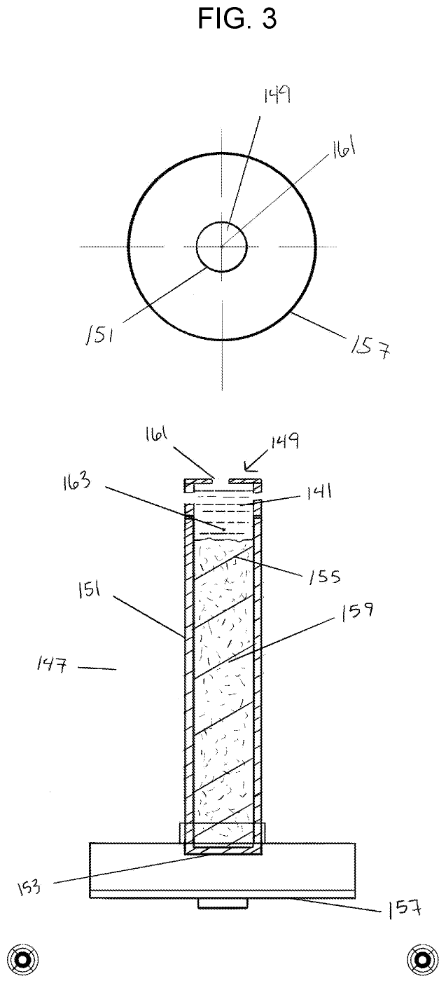

FIG. 4 is a cross sectional view of the upper cartridge member and dispensing member oriented along their vertical axis showing the, inserted within a cylindrical filter cartridge of typical structure.

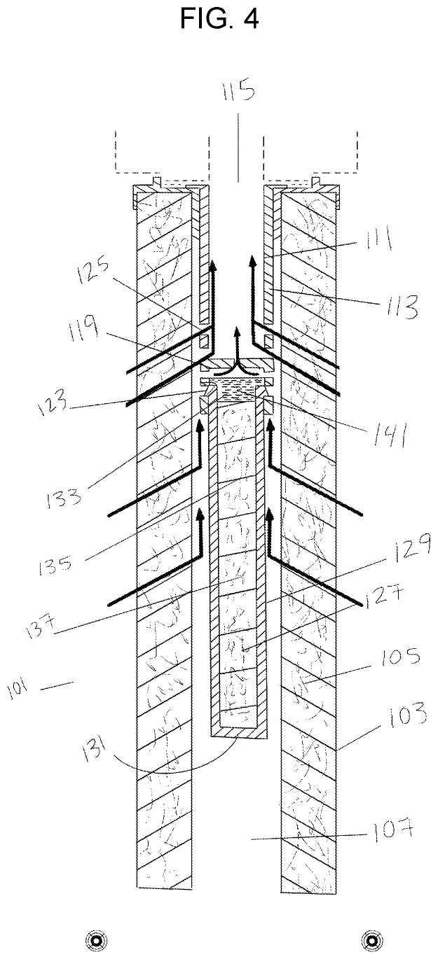

FIG. 5 is an expanded view of the chemical dispensing device showing the dispensing member separated from the upper cartridge member.

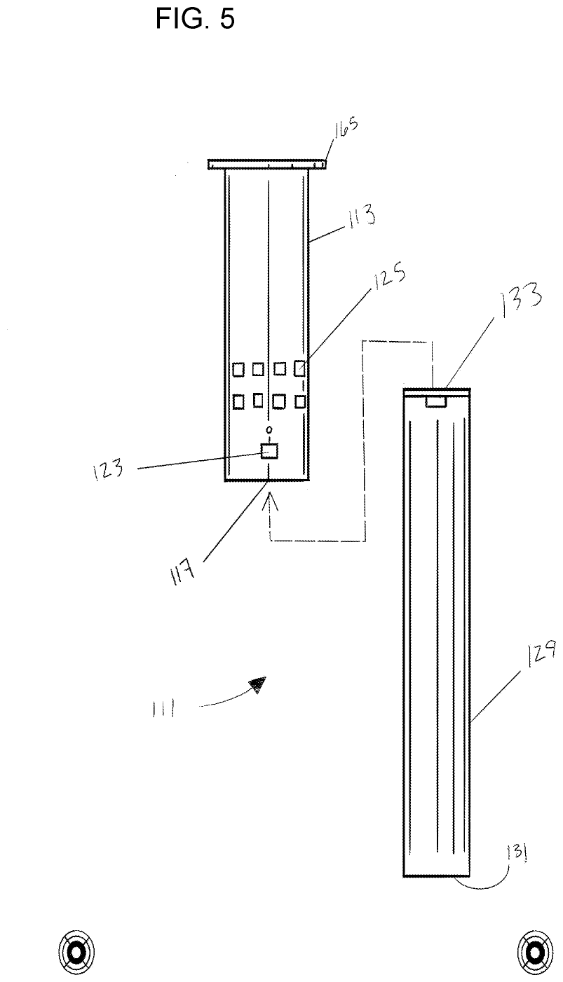

### DETAILED DESCRIPTION OF THE INVENTION

The invention will now be described in detail, in conjunction with the drawings, with regard for the best mode and preferred embodiment. The invention is a chemical dispensing device for introducing up to two chemical solutions of predetermined concentration and amount into a flow of liquid, the dispenser being incorporated within an adjoined housing and cylindrical filter cartridge connected to inflow and outflow conduits of a water or other liquid delivery system, such as found in a residential or industrial setting for one-time use or recirculation, such as for example for a spa or pool. The chemical treatment substances are presented in a solid or granular form within the chemical dispensing device and dissolve to create a saturated solution to be introduced into the liquid flow stream, the chemical being of any soluble type which imparts beneficial properties to the liquid, such as prevention of bacterial, fungal, mold or other biological growth, reduction or control of deposits of scaling, etc. The chemical treatment substances may be either two doses of the same substance such that the concentration of chemical within the saturated solution may be doubled without changing the size of the housing or dispenser elements, or be two different substances such that a single dispenser may introduce multiple chemicals into the liquid flow.

The invention is a chemical dispensing device 101, alone or in combination with a standard filter cartridge member 103. Said standard filter cartridge member 103 comprises a tubular porous filter body 105 having a hollow core 107, the upper end of which defines an outflow opening 109.

With reference to the drawings, the invention is seen in the illustrated embodiment to comprise a chemical dispensing device 101 of generally tubular configuration, the dispensing device 101 comprising a dispensing member 111 comprising a dispensing wall 113, a dispensing opening 115, and a bottom opening 117. A flow separating member 119 encompassing the entire cross-sectional area of said dispensing wall 113 bisects said dispensing wall 113 near said bottom opening 117, and a secondary outflow aperture 121 is disposed through said flow separating member 119. A secondary inflow aperture 123 is disposed through said dispensing wall 113 below said flow separating member 119. At least one flow aperture 125 is disposed through said dispensing wall 113. Said dispensing opening 115 is located opposite to said bottom opening 117 along said dispensing member 111.

The chemical dispensing device 101 further comprises a generally tubular upper cartridge member 127 comprising an upper cartridge wall 129, a closed bottom 131, and a top opening 133 that together define a hollow interior 135. A secondary chemical solute 137 is located within the hollow interior 135 and fills said hollow interior 135 such that said hollow interior 135 is essentially completely filled. Liquid entering said chemical dispensing device 101 will enter a void 139 created between said secondary chemical solute 137 and said flow separating member 119 through said secondary inflow aperture 123. The liquid will dissolve said secondary chemical solute 137, forming a saturated chemical solution 141, and pass through said secondary outflow aperture 121 into the interior of said dispensing member 111. The means for connecting said upper cartridge member 127 and dispensing member 111 may comprise as shown a pair of notches 143 disposed in said dispensing member 111 and a pair of corresponding projecting lug members 145, whereby said top opening 133 of said upper cartridge member 127 may be inserted into said bottom opening 117 of said dispensing member 111 such that said lug members 145 lock into said notches 143. Said dispensing member 111 and said upper cartridge member 127 may be permanently or temporarily joined, and the connection means may comprise mechanisms or joining means differing from that set forth in the drawings, such as for example threading, bonding or the like.

The chemical dispensing device 101 further comprises a lower cartridge member 147 comprising a cartridge top 149, a lower cartridge wall 151, and a sealed base 153, that together comprise an interior void 155. A base flange 157 extends radially outward from said sealed base 153. A primary chemical solute 159 is located within said interior void 155 such that said interior void 155 is not completely filled. A primary outflow aperture 161 is disposed through said cartridge top 149. A primary inflow aperture 163 disposed through said lower cartridge wall 151, near the upper end of said lower cartridge wall 151 and located above the upper bounds of said primary chemical solute 159. Liquid entering said chemical dispensing device 101 will enter the void created between said primary chemical solute 159 and said cartridge top 149 through said primary inflow aperture 163. The liquid will dissolve said primary chemical solute 159, contributing to said saturated chemical solution 141, and pass through said primary outflow aperture 161 into said chemical dispensing device 101. Said base flange 157 sufficiently extends from said sealing base 153 to prevent said lower cartridge member 151 from moving throughout said hollow core 107 of said filter cartridge member 103.

The chemical dispensing device 101 further comprises a transverse sealing flange member 163, said sealing flange member 165 being disposed at said dispensing opening 115 of said dispensing member 111. Said sealing flange member 165 extends radially outward from said dispensing opening 115, perpendicularly to the central axis of said dispensing member 111, and is a relatively thin member presenting generally planar upper and lower surfaces. Said sealing flange member 165 is adapted to be received and retained between an end wall 167 of said filter cartridge member 103 and the retention structure of the housing containing said filter cartridge member 103, typically in combination with a washer gasket that is compressed by the retention structure of the housing, such combinations of filter cartridge 103 and housing being well known in the art. The perimeter of said sealing flange member 165 extends radially from said dispensing wall 113 of said dispensing member 111 sufficient distance to abut a portion of said end wall 167 and thus seal said outflow opening 109 of said filter cartridge member 103 on the exterior side of said dispensing member 111, such that all water exiting said filter cartridge member 103 must flow through said chemical dispensing device 101 for treatment.

The structure of said chemical dispensing device 101 allows for the insertion of the combined dispensing member 111 and upper cartridge member 127, as well as said lower cartridge member 147 into said hollow core 107 of said filter cartridge member 103, such that only said sealing flange member 163 and base flange 157 remain external to said filter cartridge member 103. Because said sealing flange member 163 retains the chemical dispensing device 101 at said outflow opening 109, the device 101 can be utilized with filter cartridges of varying lengths and varying external diameters. The outer diameters of said dispensing member 111, upper cartridge member 127, and lower cartridge wall 151 are slightly smaller than the interior diameter of said hollow core 107 of said filter cartridge member 103 so that liquid passing through filter cartridge member 103 can readily reach said flow aperture 125.

With the chemical dispensing device 101 in place and said filter cartridge member 103 retained within the housing of said chemical dispensing device 101, liquid is directed to the exterior of the filter cartridge member 103. The housing is structured such that the only flow path for the liquid is through said porous filter body 105 into said hollow core 107. Because said dispensing opening 115 to the exterior of the chemical dispensing device 101 is sealed by said sealing flange member 163, water passes into the chemical dispensing device 101 through said inflow apertures 123, 163 and said flow aperture 125, with the vast majority of the water passing through said flow aperture 125.

Liquid entering the chemical dispensing device 101 through the inflow conduit of a liquid delivery system will pass through said filter cartridge member 103. Some portion of said liquid will enter said primary 163 and secondary 123 inflow apertures, contact said primary 159 and secondary 137 chemical solutes, and form said saturated chemical solution 141 over an extended residence time. Once said saturated chemical solution 141 is established, the large volume of liquid flowing through said flow aperture 125 creates a pressure differential that suctions some of said saturated chemical solution 141 through said secondary outflow aperture 121, which in turn draws liquid through said dispensing opening 115 into the liquid outflow. Said suction also acts to replace the liquid leaving the chemical-retaining cartridge member. The chemical solution mixes with the turbulent liquid passing through said flow aperture 125 of said dispensing member 111, ensuring that the liquid exiting the chemical dispenser device 101 is properly treated.

Said outflow apertures 121, 161 and inflow apertures 123, 163 are sized relatively small in comparison to the interior volume of cartridge 127, 147 and dispensing 111 members and in comparison to the total area of said flow aperture 125. For example, in a dispensing device having an internal diameter of approximately 1 and ⅛ inches and cartridge heights of approximately 4 and ¾ inches, the outflow apertures 121, 161 and the inflow apertures 123, 163 should be between approximately 1/32 and 3/16 inches in diameter. The size of the inflow apertures 123, 163 and flow aperture 125 determine the feed rate of the saturated chemical solution 141 into the water flow and can be varied in relation to the solubility characteristics or desirable concentrations of particular solid chemicals needed for a given application.

The amount of saturated treatment solution drawn through said secondary outflow aperture 121 is a function of aperture size, which is predetermined, and liquid flow rate. As liquid flow rate increases the pressure differential is increased and more solution is drawn out and, conversely, as liquid flow rate decreases the pressure differential decreases and less solution is drawn out. This ensures that the proper amount of saturated chemical solution 141 is introduced into the liquid flow no matter what flow rate is present. In addition, since the amount of saturated solution drawn from said cartridge members 127, 147 is relatively small in comparison to the total volume of saturated solution 141, and since the liquid drawn through inflow apertures 123, 163 is likewise of small amount relative to the total volume of the saturated solution 141, the solution within the cartridges remains in a constant, fully saturated condition. Said saturated chemical solution 141 remains at the same concentration within the chemical dispensing device 101 no matter what amount of solid chemical treatment substance is present in said upper 127 and lower 147 cartridge members since said solution 141 is always at a saturated level. Because said flow aperture 125 is located above said upper 127 and lower 147 cartridge members within the filter cartridge member 103, the replacement liquid flows into said saturated chemical solution 141 rather than into the primary 159 or secondary 137 chemical solutes, so no surging or super-saturation can occur from flow or turbulence effects within the chemical dispenser device 101.

It is contemplated that equivalents and substitutions for certain elements described and illustrated above may be obvious to those skilled in the art, and therefore the true scope and definition of the invention is to be as set forth in the following claims.

Claimed is:

1. A chemical dispenser device comprising:
a dispensing member comprising a dispensing wall, a bottom opening, a secondary inflow aperture disposed through said dispensing wall, a flow separating member bisecting said dispensing wall, a secondary outflow aperture disposed through said flow separating member, a flow aperture disposed through the outer perimeter of said dispensing wall, a dispensing opening disposed through the top of said dispensing wall, a sealing flange extending radially outward from said dispensing opening;
an upper cartridge member comprising a closed bottom, an upper cartridge wall, a top opening, a secondary chemical solute located within said upper cartridge member; and
a lower cartridge member comprising a cartridge top, a lower cartridge wall, a sealed base, a base flange extending radially outward from said sealed base, a primary outflow aperture disposed through said cartridge top, a primary inflow aperture disposed through said lower cartridge wall, and a primary chemical solute located within said lower cartridge member.

2. The device of claim 1, wherein said primary chemical solute partially fills said lower cartridge member such that a lower cartridge void exists between said primary chemical solute and said cartridge top.

3. The device of claim 2, wherein said primary inflow aperture is disposed through said lower cartridge wall into said lower cartridge void.

4. The device of claim 1, wherein said secondary chemical solute is deposited in said upper cartridge member.

5. The device of claim 1, wherein said top opening of said upper cartridge member is inserted into said bottom opening of said dispensing member.

6. The device of claim 5, wherein an upper cartridge void is formed between said secondary chemical solute and said flow separating member.

7. The device of claim 1, wherein said secondary inflow aperture is located below said flow separating member.

8. The device of claim 1, wherein said flow aperture is located above said flow separating member.

9. The device of claim 8, wherein the size of said secondary inflow aperture is small proportional to the size of said flow aperture.

10. The device of claim 9, wherein the size of said secondary outflow aperture is small proportional to the size of said flow aperture.

11. A chemical dispenser device in combination with a filter cartridge member;
said porous filter cartridge member comprising a porous filter body having a hollow core defining an outflow opening and a base;
said chemical dispenser device comprising:
A dispensing member comprising a dispensing wall, a bottom opening, a secondary inflow aperture disposed through said dispensing wall, a flow separating member bisecting said dispensing wall, a secondary outflow aperture disposed through said flow separating member, a flow aperture disposed through the outer perimeter of said dispensing wall, a dispensing opening disposed through the top of said dispensing wall, a sealing flange extending radially outward from said dispensing opening;
An upper cartridge member comprising a closed bottom, an upper cartridge wall, a top opening, a secondary chemical solute located within said upper cartridge member; and;
A lower cartridge member comprising a cartridge top, a lower cartridge wall, a sealed base, a base flange extending radially outward from said sealed base, at least one primary outflow aperture disposed through said cartridge top, a primary inflow aperture disposed through said lower cartridge wall, and a primary chemical solute located within said lower cartridge member;
wherein said dispensing member and said upper cartridge member of said chemical dispenser device are disposed within said hollow core of said filter cartridge member at said outflow opening, and said sealing flange being seated above said outflow opening, and said lower cartridge member of said chemical dispenser device is deposed within said core of said filter cartridge member at the base of said outflow opening, and said base flange encircling the base of said filter cartridge member.

12. The combination of claim 11, wherein said primary chemical solute partially fills said lower cartridge member such that a lower cartridge void exists between said primary chemical solute and said cartridge top.

13. The device of claim 12, wherein said primary inflow aperture is disposed through said lower cartridge wall into said lower cartridge void.

14. The device of claim 11, wherein said secondary chemical solute substantially fills the upper cartridge member.

15. The device of claim 11, wherein said top opening of said upper cartridge member is inserted into said bottom opening of said dispensing member.

16. The device of claim 15, wherein an upper cartridge void is formed between said secondary chemical solute and said flow separating member.

17. The device of claim 11, wherein said secondary inflow aperture is located below said flow separating member.

18. The device of claim 11, wherein said flow aperture is located above said flow separating member.

19. The device of claim 18, wherein the size of said secondary inflow aperture is small proportional to the size of each of said flow aperture.

20. The device of claim 19, wherein the size of said secondary outflow aperture is small proportional to the size of said flow aperture.
